(19) United States
(12) Patent Application Publication
(10) Pub. No.: US 2008/0240080 A1
(43) Pub. Date: Oct. 2, 2008

(54) SYSTEM AND METHOD FOR MEDIA-LEVEL REDUNDANCY IN VOICE-OVER INTERNET PROTOCOL SYSTEMS

(75) Inventor: Abhijit Patait, Milpitas, CA (US)

Correspondence Address: FENWICK & WEST LLP, SILICON VALLEY CENTER, 801 CALIFORNIA STREET, MOUNTAIN VIEW, CA, 94041, US

(73) Assignee: DITECH NETWORKS, INC., Mountain View, CA (US)

(21) Appl. No.: 11/695,389

(22) Filed: Apr. 2, 2007

(51) Int. Cl. H04L 12/66

(52) U.S. Cl. 370/352

(57) ABSTRACT

A system and method for providing media-level redundancy in voice-over Internet Protocol (VoIP) systems are disclosed. A central controller receives VoIP calls including a media transmission and call setup data and a standby allocation module included in the central controller transmits the VoIP calls to an active card and a standby card. The active card processes the media transmission of the VoIP call using an array of signal processing modules. The VoIP call setup data is also transmitted to a standby card which stores the call setup data and data identifying the active card processing the VoIP transmission in a profile database. When an active card malfunctions, the central controller transmits an activation signal to the standby card which then loads the contents of the profile database into an array of signal processing modules on the standby card to process the VoIP calls previously processed by the malfunctioning active card.

### BACKGROUND OF THE INVENTION

1. Field of Art

The present invention generally relates to the field of voice-over Internet Protocol systems, and more specifically, to a system and method for providing redundancy in voice-over-Internet Protocol systems.

2. Description of the Related Art

Recent technological advancements have increased the use of the Internet, or other Internet Protocol-based networks to route voice communications. Existing Voice over Internet Protocol (VoIP) implementations process voice calls using processing systems. These processing systems commonly use dedicated hardware comprising a plurality of media cards and signaling cards to process the received calls, which comprise a media transmission (e.g., a voice transmission) and settings for establishing and processing the call, through signaling. However, call processing fails when a hardware or software failure affects the media card used for transmission processing.

Existing processing systems either do not have a redundancy mechanism or have only a limited redundancy mechanism that forwards calls to standby media cards, which must reestablish the call, when the media card processing the call encounters an error such as a hardware or software malfunction. However, these existing methods for switching processing from an inoperative media card to a standby card require the standby card to reestablish the affected transmissions when they are received. When a card fails, existing processing systems either drop all the calls processed by the failed card and reestablish those calls when the standby card is activated or interrupt the media transmission component of the call as call setup data is transferred from failed card to standby card. Thus, when switching calls from an inoperative media card to a standby card, existing redundancy mechanisms cause the media-level connection of the call to be interrupted or lost, creating a user-detectable disruption of the media transmission. For example, if a media card handling a telephone call fails, the voice connection itself is interrupted or lost when the call is switched to a standby card and must be reestablished to continue the call.

Thus, from the above, there is a need for a redundancy mechanism capable of maintaining the media-level connection of VoIP calls.

### SUMMARY OF THE INVENTION

The present invention overcomes the deficiencies and limitations of the prior art by providing a system and method for implementing media-level redundancy in voice over Internet Protocol networks. In an embodiment, a system processes a voice over Internet Protocol (VoIP) call using a central controller for receiving the VoIP call. The VoIP call comprises a media transmission, call setup data including settings for establishing and processing the call and/or other data suitable for processing the call. The central controller includes a standby module identifying a standby card. A first card receives the VoIP call from the central controller and uses the call setup data to process the media transmission of the received VoIP call. A second card stores standby data received from the central controller. In an embodiment the standby data comprises call setup data used to establish and/or maintain VoIP call processing, such as a voice compression algorithm, settings of voice enhancement algorithms, information for initiating a call or data describing the state of the call. The standby data also stores an identifier indicating the active card processing the VoIP call. Storing standby data associated with active cards allows the standby card to be quickly configured to begin processing VoIP calls from a failed active card so a user does not experience call dropping or other noticeable interruptions.

In an embodiment, media cards are used by the system to process the VoIP call and to store standby data. The media card comprises a control module that begins processing by the media card. In an embodiment, the control module comprises an input/output module that receives VoIP calls and transmits data. A profile database is adapted to communicate with the control module, the profile database for storing the call setup data of received VoIP calls and data identifying a device processing the received VoIP calls. In an embodiment, a signal processing module is adapted to communicate with the profile database and the control module, the signal processing module for processing an input from at least one of the profile database and the control module. In another embodiment, the profile database is in the signal processing module, allowing the signal processing module to easily access the setup data.

In an embodiment, VoIP calls are processed with fault-tolerance by associating a received VoIP call with an active card and transmitting the VoIP call to the active card. Data describing the VoIP call is also transmitted to a standby card which stores the VoIP call setup data and data identifying the active card associated with the received VoIP call.

In an embodiment, a standby card is activated to process a VoIP call by receiving an activation signal identifying an inoperative active card. A profile stored locally on the standby card associated with the inoperative active card is activated. The profile comprises data describing the VoIP call associated with the inoperative active card. The data describing the VoIP call identified by the activated profile is then loaded into an array of signal processing modules and the VoIP call is routed to the standby card for processing.

The features and advantages described in the specification are not all inclusive, and in particular, many additional features and advantages will be apparent to one of ordinary skill in the art in view of the drawings, specification and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The invention is illustrated by way of example, and not by way of limitation in the figures of the accompanying drawings in which like reference numerals are used to refer to similar elements.

FIG. 1 is a block diagram of a system for processing voice over Internet Protocol (VoIP) calls using a plurality of active cards and a standby card according to one embodiment of the present invention.

FIG. 2 is a block diagram of a system for processing VoIP calls using a plurality of active cards and a plurality of standby cards according to one embodiment of the present invention.

FIG. 3 is a block diagram of a system for processing VoIP calls using a plurality of active cards, a plurality of standby cards, and at least one reconfigurable card according to one embodiment of the present invention.

FIG. 4 is a block diagram of a media card according to one embodiment of the present invention.

FIG. 5 is a flow chart of media card initialization according to one embodiment of the present invention.

FIG. 6 is a flow chart of fault-tolerant VoIP call processing according to one embodiment of the present invention.

FIG. 7 is a flow chart of fault compensation according to one embodiment of the present invention.

### DETAILED DESCRIPTION OF EMBODIMENTS

Reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will be apparent from the description below. In addition, the present invention is not described with reference to any particular programming language. It will be appreciated that a variety of programming languages may be used to implement the teachings of the invention as described herein.

Moreover, the present invention claimed below may operate on or work in conjunction with an information system or network. Thus, the present invention is capable of operating with any information system from those with minimal functionality to those providing all the functionality disclosed herein. Although described herein as operating with voice-over Internet Protocol calls (VoIP) and VoIP systems, the present invention is capable of operating with any information system where multiple devices receive and process data.

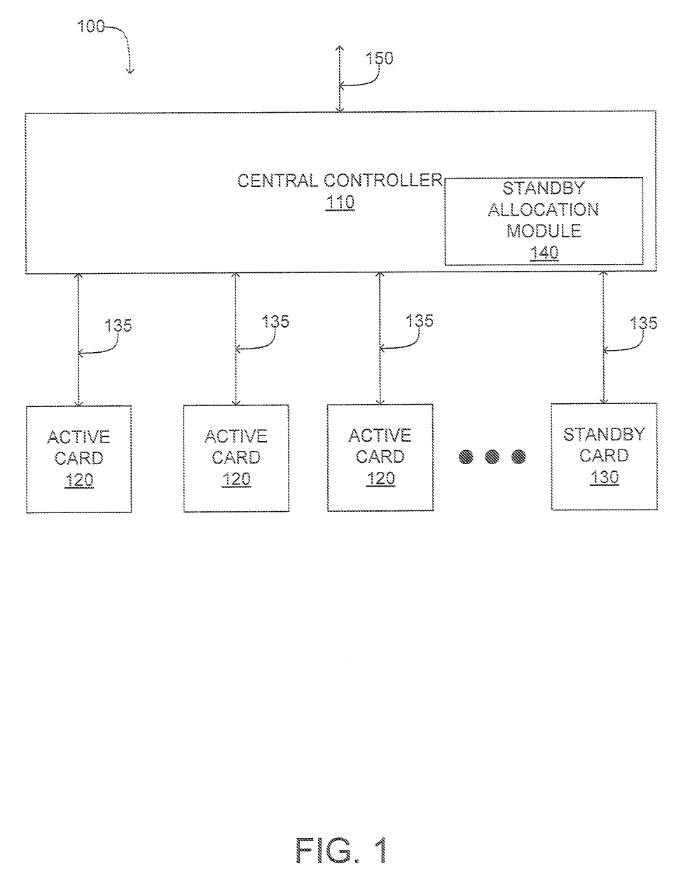

Referring now to FIG. 1, a block diagram of a system 100 for processing voice-over Internet Protocol (VoIP) calls using a plurality of active cards 120 and a standby card 130 is shown. The system 100 also includes a central controller 110 and a bus 135 allowing the central controller 110, active card 120 and standby card 130 to communicate with each other. In an embodiment, the central controller 110 also includes a standby allocation module 140.

The central controller 110 receives VoIP calls from multiple sources via signal line 150 and routes the received transmissions to the active cards 120 and the standby card 130. The VoIP calls comprise a media transmission, such as voice data, and call setup data including settings for establishing and processing the call and/or other data suitable for processing the media transmission. In an embodiment, the central controller 110 comprises software configured to run on a general purpose processor. The processor (not shown) may comprise various computing architectures including a complex instruction set computer (CISC) architecture, a reduced instruction set computer (RISC) architecture, or an architecture implementing a combination of instruction sets. Multiple processors may be used for the central controller 110. In an embodiment, the processor comprises an arithmetic logic unit, a microprocessor, or some other information appliance equipped to process received electronic signals and provide electronic signals.

Alternatively, the central controller 110 may comprise a field-programmable gate array (FPGA), application-specific integrated circuit (ASIC) or another device capable of processing an input signal or performing actions responsive to an input signal. In an embodiment, the central controller 110 comprises a combination of ASICs, FPGAs, memory elements, combinatorial logic or other devices capable of receiving and processing input signals.

Additionally, the central controller 110 determines enhancements or modifications applicable to the received calls and communicates the enhancements or modifications to the active cards 120 and the standby card 130. For example, the central controller 110 indicates that audio enhancement, echo cancellation, noise filtering, or other modifications are to be applied to a received media transmission. The central controller 110 transmits these operations, or settings describing these operations, to the active cards 120, which enhances or modifies the media transmission accordingly. In an embodiment, data describing the modifications or enhancements, such as parameters or settings for an algorithm, are also transmitted to the standby card 130 where they are stored and associated with the call.

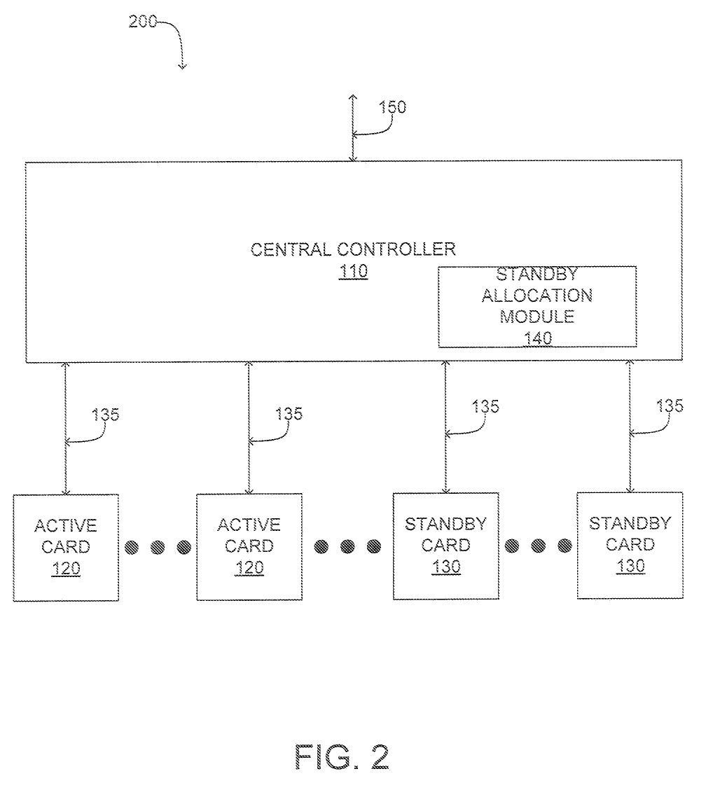

The standby allocation module 140 stores data identifying the standby card 130. In an embodiment, standby allocation module 140 is a dynamic random access memory (DRAM) device, a static random access memory (SRAM) device, Flash RAM (non-volatile storage), combinations of the above, or another suitable memory device. Alternatively, the standby allocation module 140 comprises a processor capable of processing input data signals and generating an output data signal which identifies the standby card 130. In another embodiment, the standby allocation module 140 receives and stores input data from the standby card 130 (See FIG. 2) and active cards 120 identifying whether the card processes media transmissions or stores standby data. The data identifying the standby card 130 comprises a hardware address, a serial number, or other data capable of identifying the standby card 130. The identity of the standby card 130 may be fixed or dynamically specified by the standby allocation module 130 during operation. In an embodiment, the standby allocation module 140 receives user input and modifies the identity of the standby card 130 accordingly, allowing a user to specify the identity of the standby card 130.

A system bus 135 communicates information and data between the central controller 110, the active cards 120 and the standby card 130. The system bus 135 may represent one or more buses including an industry standard architecture (ISA) bus, a peripheral component interconnect (PCI) bus, a universal serial bus (USB), an inter-integrated circuit (I2C) bus, a serial peripheral interface (SPI), a proprietary bus configuration or other suitable bus that provides similar functionality.

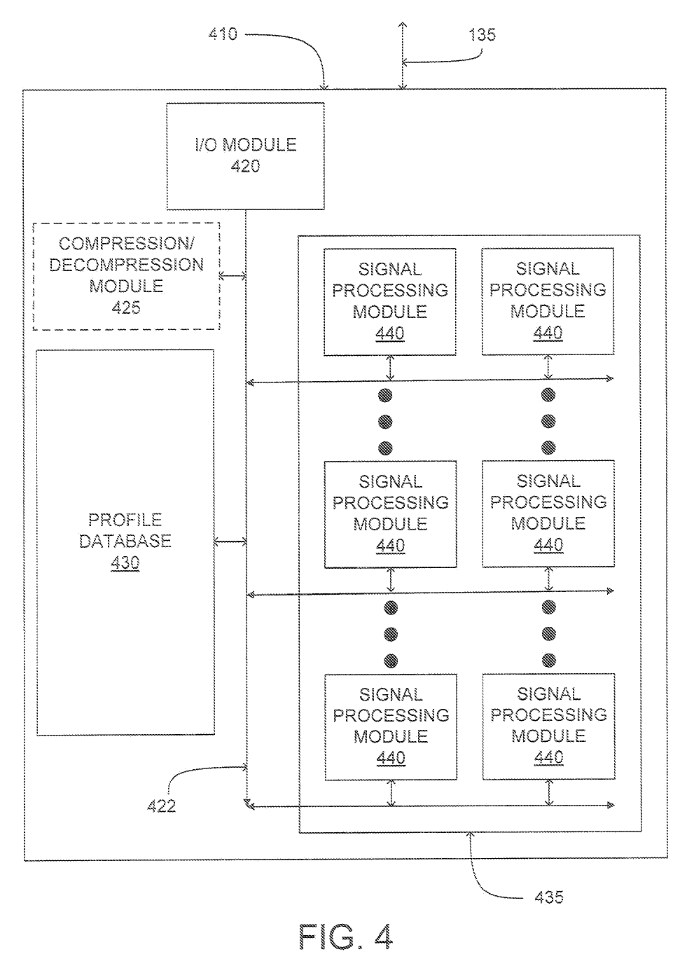

One or more active cards 120 are adapted to communicate with the central controller 110. Each active card 120 receives VoIP calls from the central controller 110 and processes the media transmission component of the VoIP calls. The active cards 120 enhance or modify the media transmission according to information provided by the central controller 110 or according to algorithms applied by the active cards 120. For example, the active cards 120 enhance the audio component of the media transmission or apply echo cancellation to the media transmission. The structure of the active cards 120 is further described below in conjunction with FIG. 4. In an embodiment, the same structure is used for the active cards 120 and the standby card 130 to simplify design and maintenance of the system 100.

A standby card 130 stores information about VoIP transmissions being processed by the active cards 120. The standby card 130 receives and stores the call setup data component of received VoIP calls from the central controller 110 describing how the media transmission is established and processed by the active card 120 currently processing the media transmission. When an active card 120 fails, the standby card 130 uses the stored call setup data to take the place of the active card 120; thus, in the event of an active card 120 failure, the standby card 130 is converted to an active card 120 by using the stored call setup data to process the media transmission component of the VoIP calls previously processed by the failed active card 120. This allows the standby card 130 to begin processing the media transmissions without interruption by loading the locally stored call setup data to configure the standby card 130 for media transmission processing. In an embodiment, the active cards 120 and the standby card 130 have the same components, allowing a single media card design and/or structure, such as the structure described below in conjunction with FIG. 4, to be used for both the active cards 120 and the standby cards 130.

FIG. 2 shows a block diagram of a system 200 using a plurality of active cards 120 and a plurality of standby cards 210 for processing VoIP calls according to one embodiment of the present invention. The system 200 comprises a central controller 110, a plurality of active cards 120, a plurality of standby cards 130 and a bus 135 communicating data between the active cards 120, the standby cards 130 and the central controller 110.

The central controller 110 comprises a standby allocation module 140 including data identifying the active cards 120 and standby cards 130. In system 200, the standby allocation module 140 stores data identifying the multiple standby cards 130. In an embodiment, the number of standby cards 130 in use is dynamically determined and/or modified by the standby allocation module 140. For example, as the number of VoIP calls received by the central controller 110 increases, the standby allocation module 140 increases the number of standby cards 130 storing call setup data for the received VoIP calls. Similarly, as the number of received VoIP calls decreases, the standby allocation module 140 decreases the number of standby cards 130 in use. Alternatively, the standby allocation module 140 may alter the number of standby cards 130 in use responsive to user input, transmission quality, or any other suitable criteria.

In one embodiment, each standby card 130 stores standby data, or call setup data, describing VoIP calls, such as voice compression algorithms, call setup parameters, voice enhancement settings or other suitable data, associated with a subset of the active cards 120. For example, in a system with 20 active cards 120 and 4 standby cards 130, each standby card 130 stores call setup data associated with 5 active cards 120. Alternatively, each standby card 130 stores call setup data associated with the active cards 120 in use. In the above-described example with 20 active cards 120 and 4 standby cards 130, the 4 standby cards 130 each store call setup data associated with the 20 active cards 120. This allows each standby card 130 to maintain a complete description of the state of the currently used active cards 120. Thus, each standby card 130 can be used to duplicate the processing of the currently used active cards 120. In another embodiment, one standby card 130 stores call setup data associated with all active cards 120, so in the above-described example with 4 standby cards 130 and 20 active cards 120, one standby card 130 stores data associated with 20 active cards 120. When one of the active cards 120 fails and the standby card 130 processes the media transmission component of the VoIP calls, one of the remaining 3 standby cards 130 is then used to store data associated with the active cards 120.

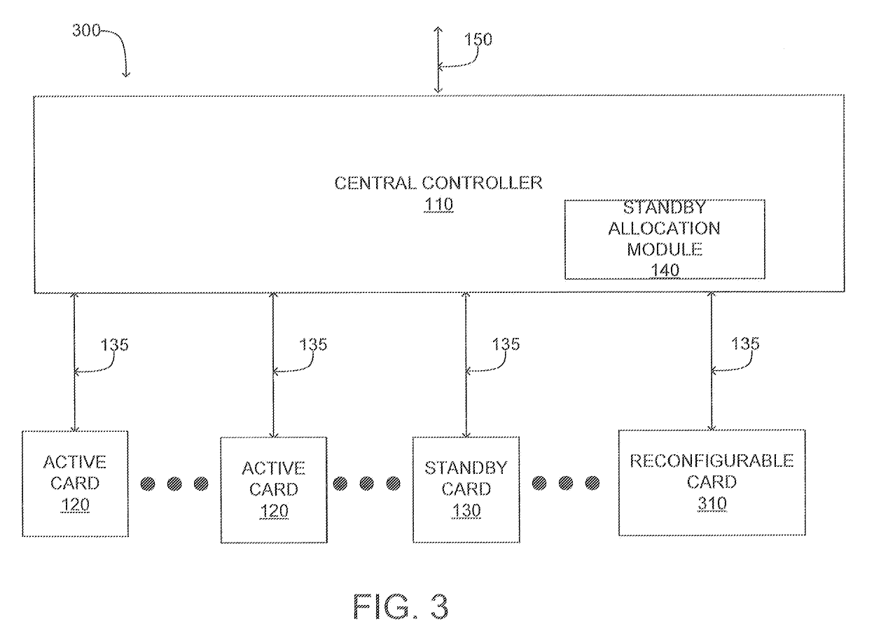

FIG. 3 illustrates a system for processing VoIP calls using a plurality of active cards 120, a plurality of standby cards 130, and at least one reconfigurable card 310 according to one embodiment of the present invention. The system 300 comprises a central controller 110, a plurality of active cards 120, a plurality of standby cards 130, one or more reconfigurable cards 310 and a bus 135 connecting the components.

The reconfigurable cards 310 are dynamically configurable to function as either active cards 120 or standby cards 130, and may be reconfigured while the system 300 operates. The standby allocation module 140 alters how the central controller 110 identifies the reconfigurable card 310 depending on a parameter or combination of parameters. Responsive to one value of the parameter or parameters, the standby allocation module 140 identifies the reconfigurable card 310 as an active card 120 causing the central controller 110 to forward calls for processing to the reconfigurable card 120. Other values of the parameter or parameters cause the standby allocation module 140 to identify the reconfigurable card 310 as a standby card 130 which receives and stores data from the central controller 110 describing call setup data and the active card or active cards 120 currently processing the calls.

Using reconfigurable cards 310 allows the system 300 to adjust the number of VoIP calls being processed and the amount of redundancy in the system 300 as conditions change. For example, when the number of received VoIP calls increases, the standby allocation module 140 identifies more reconfigurable cards 310 as active cards 120 and fewer reconfigurable cards 310 as standby cards 120. This increases the number of VoIP calls the system 300 is capable of processing. Alternatively, when quality of service and maintenance of the VoIP calls is critical, standby allocation module 140 increases the number of reconfigurable cards 310 identified as standby cards 130 and reduces the number of reconfigurable cards 310 identified as active cards 120. This increases the number of standby cards 130 storing data describing the VoIP calls and preventing processing disruption in the event of an active card 120 failure, thereby increasing fault tolerance. Thus, using reconfigurable cards 310 enables the system 300 to adjust the number of active cards 120 by modifying the reconfigurable cards 310 to process VoIP calls. Similarly, the system 300 can modify the reconfigurable cards 310 to increase the number of standby cards 130 in use to provide greater VoIP call processing redundancy.

FIG. 4 illustrates a block diagram of a media card 410 according to an embodiment of the invention. The media card 410 is used to implement the active cards 120, the standby cards 130 and/or the reconfigurable cards 310. The media card 410 may include more or less components than those shown in FIG. 4 without departing from the spirit and scope of the present invention.

The input/output module 420 links the media card 410 with the central controller 110, or other information processing system. The input/output module 420 receives data from the system bus 135 and communicates the received data to the components of the media card 410 using internal bus 422. In an embodiment, the input/output module 420 comprises an industry standard architecture (ISA) controller, a peripheral component interconnect (PCI) controller, a universal serial bus (USB) controller, an (inter-integrated circuit) I2C controller, a serial peripheral interface (SPI) controller or other suitable controller capable of receiving data from the system bus 135 and communicating the received data using internal bus 422. In an embodiment, the input/output module 420 converts the received data from a first format used by the system bus 135 to a second format used by the internal bus 422. Alternatively, the system bus 135 and the internal bus 422 use the same data format and input/output module 420 routes the received data to different components of the media card 410.

In an embodiment, the media card 410 includes a compression/decompression module 425 to compress and/or decompress information received from the central controller 110. The compression/decompression module 425 is a processor (not shown) and software configured to run on the processor that applies a compression or decompression algorithm to received data. In an embodiment, the compression/decompression module 425 compresses different types of data by different amounts or modifies the amount of data compression responsive to user input or changing system conditions. Alternatively, the compression/decompression module 425 compresses a portion of the data received from the central controller 110 and does not compress a portion of the received data. Similarly, in an embodiment, the compression/decompression module 425 determines whether a portion of the data is compressed and decompresses the appropriate portion. Alternatively, the compression/decompression module 425 applies a decompression module to the complete received data. Using the compression/decompression module 425 to compress the received data increases the amount of data a media card can store. When the media card 410 acts as a standby card 130, the compression/decompression module 425 increases the amount of call setup data stored, increasing the number of active cards 120 associated with the standby card 130 or increasing the amount of detail about call processing included in the call setup data or the other standby data.

The profile database 430 stores call setup data describing received VoIP calls processed by other media cards 410. For example, the profile database 430 stores standby data indicating voice compression algorithms, or codecs, used for the media transmission, real-time transport protocol (RTP) or real time control protocol (RTCP) parameters used for the call, proprietary signal processing data such as voice enhancement algorithm settings, jitter buffer settings, voice quality monitoring information or any other data associated with the VoIP calls. In an embodiment, the profile database 430 additionally stores data describing the status of VoIP calls processed by other media cards 410. The profile database 430 may be a hard disk drive, a flash memory device, or some other suitable non-volatile mass storage device. In one embodiment, the profile database 430 comprises a volatile storage device, such as a dynamic random access memory device (DRAM), a static random access memory device (SRAM), or other suitable memory device. Alternatively, the profile database 430 may be a combination of volatile and non-volatile memory devices. The profile database 430 stores data associating transmissions with an active card 120, data describing the VoIP call and, optionally, the status of each currently active VoIP call. In an embodiment, the stored status of the currently active VoIP calls is periodically updated with revised data, allowing processing of VoIP call media transmission to continue, using current status data, without disruption when an active card 120 fails. In an embodiment, the profile database 430 stores data describing the transmissions processed by the active cards 120 being used by the system. Alternatively, the profile database 430 stores data describing VoIP calls processed by a subset of the active cards 120.

An array 435 of signal processing modules 440 processes the media transmission VoIP call component and modifies or enhances the media transmissions. In an embodiment, the signal processing modules comprise digital signal processors (DSPs). Alternatively, the signal processing modules 440 comprise field programmable gate array (FPGA) devices programmed to apply digital signal processing operations to data. In other embodiments, the signal processing modules 440 comprise any device capable of applying digital signal processing operations to received data. In an embodiment, each signal processing module 440 in the array 435 processes one or more VoIP calls. Each signal processing module 440 is capable of simultaneously processing multiple VoIP calls. In an embodiment, each signal processing module 440 in the array 435 processes a different number of transmissions.

In an embodiment, the profile database 430 is divided into a plurality of segments, with a segment associated with a signal processing module 440. This causes the profile database 430 segment to store call setup data, or standby data, describing VoIP call processing by a corresponding signal processing module 440 on an active card 120 processes VoIP calls. Alternatively, the signal processing module 440 also includes a profile database 430 which stores call setup data describing how the signal processing module 440 processes media transmissions. In an embodiment, the profile database 430 portion associated with a signal processing module is embedded within the signal processing module 440, allowing necessary call setup data to be locally stored by the signal processing module 440.

These configurations are provided only by way of example, as long as areas or components for the described functionality are offered, various other configurations are encompassed within the claimed invention.

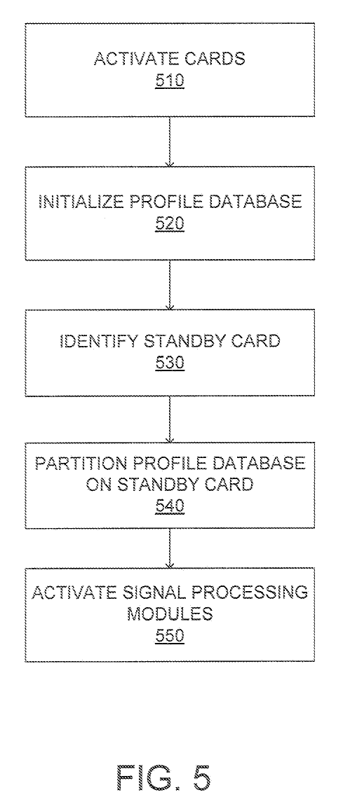

FIG. 5 shows a flow chart of media card 410 initialization by the central controller 110 according to an embodiment of the invention. The central controller 110 initializes the active cards 120, standby cards 130 and/or reconfigurable cards 310 prior to receiving VoIP calls. In various embodiments, the media card 410 and central controller 110 are each capable of performing any step, or combination of steps, in the initialization described by FIG. 5.

Initially, the central controller 110 activates 510 the media cards 410 by transmitting an activation signal to a media card 410 using the bus 135. After activation 510, the profile database 430 on the media card 410 is initialized 520. In an embodiment, initialization 520 comprises erasing data previously stored in the profile database 430. Configuration data is also stored to the profile database 430 during initialization 520. For example, configuration data indicating the number of active cards 120 in the system, identifiers for each active card 120 or other data describing system operation and parameters is stored in the profile database 430.

At least one standby card 130 is then identified 530. In an embodiment, the standby card 130 is identified 530 by storing data in the standby allocation module 140 indicating that the standby card 130 stores standby data describing how to process the VoIP call, but does not process the media transmission of the VoIP call, and identifying the active card 120 processing the VoIP call media transmission. In an embodiment, data is pre-loaded into the standby allocation module 140, such as a hardware address, serial number, network address or other identification data that identifies 530 the standby card 130. Alternatively, the standby allocation module 140 uses a software module or other selection method to identify 530 the standby card 130 according to an algorithm or other defined instruction set. In an embodiment, the standby allocation module 140 dynamically selects the identity of the standby cards 130 and the number of standby cards 130 in response to system operation or parameters. In an alternate embodiment, a user provides input commands and/or data to the standby allocation module to specify or modify the identity of the standby cards 130.

The profile database 430 on the identified 530 standby card 130 is then partitioned 540 into a plurality of portions. In an embodiment, the profile database 430 is partitioned 540 into equal-sized portions. Alternatively, the profile database 430 is partitioned 540 into differently-sized portions proportional to the size of the transmissions processed by each active card 120, or based on another suitable metric. In another embodiment, the size of the partitions is dynamically modified as the number of active cards 120 in use varies. Alternatively, the profile database 430 is partitioned 540 into a plurality of segments and each segment is associated with a signal processing module 440. This allows a segment of the profile database 430 to contain the complete call setup data and other standby data needed for a signal processing module 440 to process VoIP calls without interrupting the media transmission. For example, the data stored in a segment of the profile database 430 allows the signal processing module 440 to begin processing VoIP calls in less than 50 ms, so that there is no detectable disruption of the media transmission, so that a packet loss concealment (PLC) algorithm, if used, can more easily recreate segments of the media transmission lost when the VoIP call is transferred from a failed active card 120 to a standby card 130. In another embodiment, the profile database 430 is included in the signal processing module 440 and is partitioned 540 responsive to the number of VoIP calls processed by a corresponding signal processing module 440 on an active card 120.

The signal processing modules 440 on the media card 410 are then activated 550 by receiving an initialization signal. Activating 550 the signal processing modules 440 on the media card 410 causes the signal processing modules 440 to be ready for processing input media transmissions when received. Even if the activated 510 media card 410 is a standby card 130, the signal processing modules 440 are activated 550 so they are ready to process media transmission components of VoIP calls once an active card 120 malfunctions and the standby card 130 receives the VoIP calls previously processed by the failed active card 120.

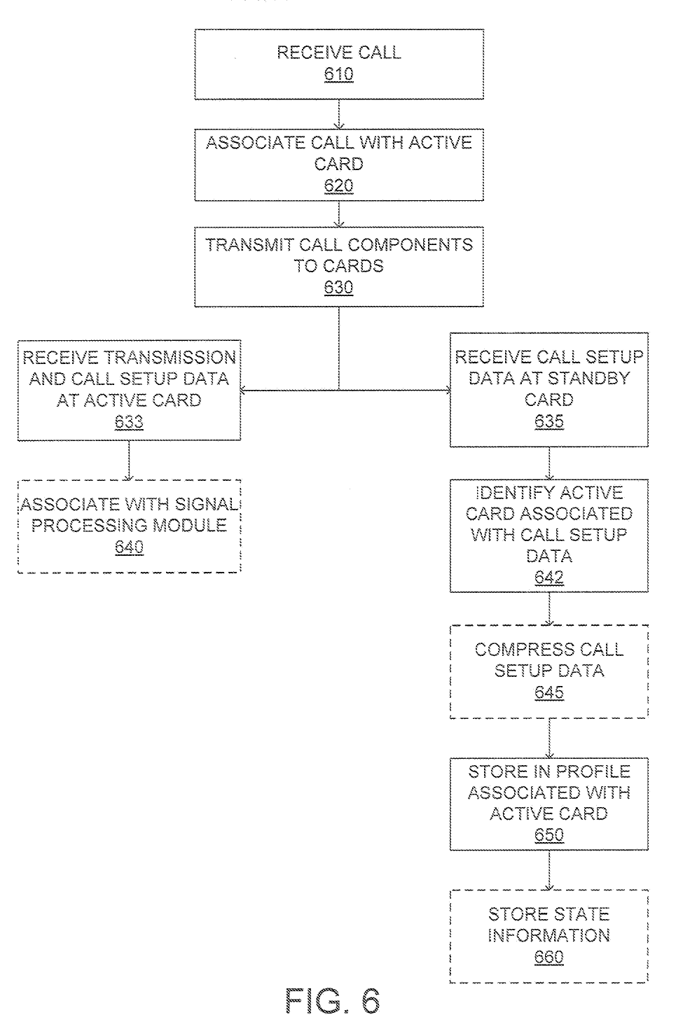

FIG. 6 illustrates a flow chart of a method for fault-tolerant processing of VoIP calls according to one embodiment of the present invention.

Initially, a VoIP call, comprising a media transmission (such as a voice call) and call setup data, is received 610 by the central controller 110 and associated 620 with an active card 120. Alternatively, the received 610 VoIP call comprises data from an established call between two or more parties. Associating 620 identifies an active card 120 used to process and/or enhance the received 610 transmission. In an embodiment, associating 620 further comprises identifying a signal processing module 440 on the active card 120 for processing the received 610 transmission.

After associating 620 the VoIP call with an active card 120, the call setup data, such as voice compression algorithms (e.g., codecs or other suitable algorithms), configuration parameters or other signal processing data, and the media transmission are transmitted 630 from the central controller 110 to the associated 620 active card 120 using the system bus 135. The call setup data is also transmitted 630 to a standby card 130 via system bus 135. After receiving 635 the call setup data, the standby card 130 identifies 642 the active card 120 associated 620 with the received 635 call setup data. In an embodiment, this identification 642 comprises extracting an identifier of the active card 120 associated 620 with the VoIP call from the call setup data. Alternatively, the standby card 130 separately receives 635 data associating transmissions with active cards 120 to identify 642 the corresponding active card 120. Optionally, when the standby card 130 receives 635 the call setup data, the standby card 130 compresses 645 the received 635 call setup data.

The standby card 130 then stores 660 the received 635 call setup data and associated 620 active card identifier 120 in the profile database 430. In an embodiment, the call setup data is stored in a partition of the profile database 430 corresponding to the associated 620 active card, allowing different portions of the profile database 430 to maintain current data of the transmission processing by different active cards 120. Thus, the profile database 430 of the standby card 130 stores 650 data describing how to process the VoIP call media transmissions currently processed by the active card 120. Locally storing 650 this data allows the standby card 130 to quickly load and begin processing media transmissions without interruption when an active card 120 fails. In an embodiment, the received 635 call setup data further comprises state information, such as the current status or configuration of voice processing algorithms, packet statistics or other data applicable to transmission processing. This additional state information is also stored 660 by the standby card in the profile database 430 to further reduce the time needed for the standby card 130 to begin processing media transmissions when an active card 120 fails. In an embodiment, the state information is periodically updated to store the most current state of the VoIP call processing. Thus, the standby card 130 stores call setup data and current processing state or other data describing current VoIP call processing by an active card 120.

Additionally, the received 610 VoIP call, including call setup data and a media transmission, is transmitted 630 via the system bus 135 to the associated 620 active card 120. In one embodiment, state information data describing enhancements, modifications or current status to the received 610 transmission is also transmitted 630 to the active card 120. The associated 620 active card 120 uses the state information to modify or enhance the transmission by applying noise cancellation algorithms, echo cancellation algorithms or other techniques to improve transmission quality. In another embodiment, the state information also comprises data describing signal quality or network performance, such as signal-to-noise ratio, network jitter and/or other packet statistics, voice or conversation quality metrics, signal levels, echo levels, overall quality of service or other metrics capable of describing network performance or transmission quality. In an embodiment, the active card 120, rather than the central controller 110, then associates 640 the VoIP call with a signal processing module 440 for processing.

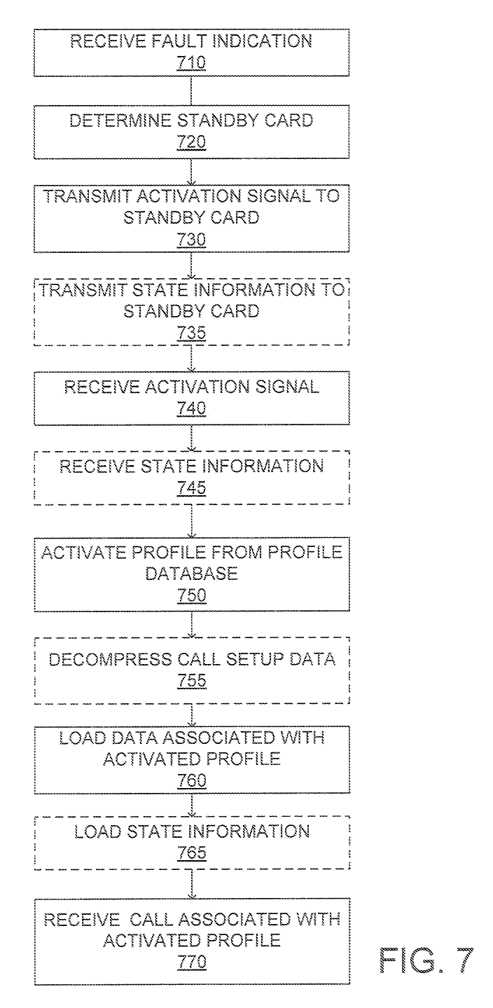

FIG. 7 is a flow chart illustrating fault compensation according to one embodiment of the present invention.

Upon receiving 710 an indication that one of the active cards 120 is inoperative, the central controller 110 determines 720 the standby card 130 associated with the inoperative active card 120. In an embodiment, a standby card 130 stores call setup data associated with each active card 120. Alternatively, a standby card 130 stores call setup data associated with a subset of the active cards 120. The central controller 110 determines 720 the standby card 130 associated with the failed active card 120 by examining a predefined data set, applying an algorithm, executing a command, or other suitable methods.

An activation signal is then transmitted 730 to the standby card 130 via bus 135. The activation signal identifies the inoperative active card 120 and indicates the standby card 130 is to begin processing VoIP calls associated with the inoperative active card 120. Upon transmitting 730 the activation signal, the standby allocation module 140 is updated to indicate the standby card 130 is being used as an active card 120. Transmission 730 of the activation signal also causes the central controller 110 to route subsequent media transmissions or other data associated with the VoIP calls previously processed by the inoperative active card 120 to the standby card 130 for processing.

In an embodiment, state information is also transmitted 735 to the standby card 130 upon failure of an active card 120. The state information comprises data describing characteristics of the transmissions, such as enhancements or modifications applied to the transmission by an active card 120, or other data associated with the transmission or processing of the transmission. For example, the state information may be a signal-to-noise ratio, an echo measurement, a delay value or other information capable of describing transmission quality. In an embodiment, the state information identifies voice quality enhancements applied to the transmission, such as noise cancellation algorithms or echo cancellation algorithms. Alternatively, state information is periodically transmitted 735 to the standby card 130 and stored while the active card 120 is operating, so rather than transmitting 735 the state information to the standby card 130 upon active call failure 120, the previously stored state information is loaded 760 and used for processing. Storing the state information on the standby card 130 allows previously computed state information to be preserved, and later used, when the standby card 130 is used to process a VoIP call. Alternatively, no state information is transmitted 735 and the signal processing module 440 on the standby card 130 applies enhancements or modifications to the transmission based on the locally-stored call setup data and the media transmission component of the VoIP call. Although omitting the state transmission step allows the VoIP call to be processed without interruption using the call setup data stored in the profile database 430, it involves the calculation of new state information by the standby card 130 after call processing is initiated.

Upon receiving 740 the activation signal, and optionally receiving 745 the state information, the standby card 130 activates 750 the profile corresponding to the identified inoperative active card 120. A signal processing module 440 on the standby card 130 then accesses the profile database 430 and loads 760 the standby data describing how to load and process the received transmission or transmissions associated with the failed active card 120. In an embodiment, the standby card 130 decompresses 755 the stored call setup data and/or state information before loading 760 the data into the signal processing module 440. Because the signal processing module 440 is activated when the standby 130 card is activated 510, the signal processing module 440 can immediately begin processing received media transmissions after loading the stored standby data. In an embodiment, the standby data stored in the profile database 430 enables the standby card 130 to begin processing received media transmissions in less than 50 ms, and as quickly as 20 ms, so that a user does not detect any disruption in the media transmission when the standby card 130 begins processing VoIP calls.

Receiving 740 the activation signal allows the already running signal processing modules 440 to retrieve configuration data and/or state information associated with the inoperative active card 120 in parallel from the profile database 430, allowing the signal processing modules to begin processing media transmissions previously processed by the failed active card without interruption, or with an undetectable interruption, of media transmission processing. When state information is also received 745, the state information is also loaded 765 into the signal processing module 440 and used to enhance, modify, monitor or otherwise process the VoIP call (e.g., continuing prior measurements of various voice quality metrics or other data collected by the failed active card 120, or other data analysis). Receiving 745 the state data enables the signal processing module 440 on the standby card 130 to quickly apply the same processing techniques as the failed active card.

After receiving 740 the activation signal, the standby card 130 receives 770 VoIP calls associated with the activated 750 profile, allowing the standby card 130 to provide the same VoIP call processing functionality as the failed active card 120. In an embodiment, the standby card receives 770 the calls processed by the failed active card one at a time, so the central controller 110 migrates each VoIP call from the failed active card to the standby card. Alternatively, the central controller 110 migrates a group of the VoIP calls processed by the failed active card 120 to the standby card 130, which then receives 770 these VoIP calls as a group.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Of course, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A system for processing a voice over Internet Protocol call comprising:
a central controller for receiving the voice-over Internet Protocol call, the central controller identifying a standby card;
a first card for receiving the voice-over Internet Protocol call from the central controller and for processing the voice over Internet Protocol call; and
a second card for storing standby data received from the central controller, the standby data comprising the voice over Internet Protocol call setup data and an identifier indicating the active card processing the voice over Internet Protocol call.

2. The system of claim 1, wherein the central controller comprises a standby allocation module for identifying the second card and for routing the voice-over Internet Protocol call to the second card.

3. The system of claim 2, wherein the routing the voice-over Internet Protocol to the second card occurs in at most 50 ms.

4. The system of claim 1, wherein the second card comprises a profile database for storing the standby data.

5. The system of claim 4, wherein the second card further comprises a compression/decompression module for compressing the stored standby data.

6. The system of claim 1 further comprising:
a reconfigurable card for receiving a configuration signal from the central controller, wherein
responsive to a first value of the configuration signal, the reconfigurable card receives the voice over Internet Protocol call from the central controller and processes the voice over Internet Protocol call, and
responsive to a second value of the configuration signal, the reconfigurable card stores the standby data in a local profile database.

7. The system of claim 1, further comprising a plurality of active cards.

8. The system of claim 1, further comprising a plurality of standby cards.

9. An apparatus for processing a voice over Internet Protocol call comprising:
a control module for starting processing by the apparatus; and
a profile database adapted to communicate with the control module for storing data describing the voice over Internet Protocol call and data identifying a device processing the voice over Internet Protocol transmission

10. The apparatus of claim 9, further comprising:
a signal processing module adapted to communicate with the profile database and the control module, the signal processing module for processing an input from at least one of the profile database and the control module.

11. The apparatus of claim 10, wherein the profile database is in the signal processing module.

12. The apparatus of claim 9, wherein the control module comprises an input/output module for receiving the voice over Internet Protocol call from a central controller and for transmitting data;

13. The apparatus of claim 10 further comprising an array of signal processing modules adapted to communicate with the profile database and the control module, the array for processing input from at least one of the profile database and the control module.

14. The apparatus of claim 9, wherein the profile database comprises a plurality of portions, each portion associated with a device processing the voice over Internet Protocol call.

15. The apparatus of claim 12, wherein the input/output module further receives data associated with the voice over Internet Protocol call.

16. The apparatus of claim 12, further comprising a compression/decompression module for performing at least one of decompressing the received data associated with the voice over Internet Protocol call or compressing the received data associated with the voice-over Internet Protocol call.

17. The apparatus of claim 9, wherein the profile database stores the received data associated with the voice over Internet Protocol call.

18. A method for processing a voice-over Internet Protocol call with fault tolerance, the method comprising:
associating the voice over Internet Protocol call with an active card;
transmitting the voice over Internet Protocol call data to the associated active card;
transmitting data describing the voice over Internet Protocol call and data identifying the associated active card to a standby card;
storing, on the standby card, the data describing the voice over Internet Protocol call and the data identifying the associated active card.

19. The method of claim 18, further comprising:
transmitting data associated with the voice over Internet Protocol call to the associated active card;
transmitting the data associated with the voice over Internet Protocol call to the standby card and
storing, on the standby card, the data associated with the voice over Internet Protocol call.

20. The method of claim 18, wherein storing on the standby card comprises:
storing the data describing the voice over Internet Protocol call and the data identifying the associated active card into a profile database.

21. The method of claim 19, wherein the data associated with the voice over Internet Protocol call comprises voice quality measurements.

22. The method of claim 19, wherein the data associated with the voice over Internet Protocol call comprises enhancement operations applicable to the voice over Internet Protocol call.

23. The method of claim 18, further comprising transmitting an activation signal to the standby card, wherein the activation signal reconfigures the standby card to process the voice over Internet Protocol call.

24. A method for activating a standby card to process a voice over Internet Protocol call, the method comprising:
receiving an activation signal identifying an inoperative active card;
activating a profile associated with the inoperative active card, the profile stored locally on the standby card, wherein the profile identifies the voice over Internet Protocol call associated with the inoperative active card;
loading the voice over Internet Protocol call identified by the activated profile into an array of signal processing modules on the standby card; and
processing the voice over Internet Protocol call using the array of signal processing modules.

25. The method of claim 24, further comprising loading state information associated with the voice over Internet Protocol call into the array of signal processing modules on the standby card.

26. The method of claim 20, wherein the voice quality measurements are updated by periodic transmission of revised voice quality measurements to the standby card
